(19) United States
(12) Patent Application Publication
(10) Pub. No.: US 2023/0406304 A1
(43) Pub. Date: Dec. 21, 2023

(54) METHOD FOR TRAINING A DEEP-LEARNING-BASED MACHINE LEARNING ALGORITHM

(71) Applicant: Robert Bosch GmbH, Stuttgart (DE)

(72) Inventors: Amulya Hiremath, Bangalore (IN); Barbara Rakitsch, Stuttgart (DE); Gonca Guersun, Stuttgart (DE); Joerg Wagner, Renningen (DE); Michael Herman, Sindelfingen (DE); Nils Oliver Ferguson, Weil Der Stadt (DE); Rahul Pandey, Karnataka (IN); Yu Yao, Herzogenrath (DE)

(21) Appl. No.: 18/297,145

(22) Filed: Apr. 7, 2023

(30) Foreign Application Priority Data
Jun. 14, 2022 (DE) 10 2022 205 999.9

(51) Int. Cl. B60W 30/17; B60W 30/08; G06N 20/00

(52) U.S. Cl. CPC B60W 30/17; G06N 20/00; B60W 30/08

(57) ABSTRACT

A method for training a deep-learning-based machine learning algorithm. The method includes: providing training data for training the deep-learning-based machine learning algorithm, wherein the training data comprise sensor data; training, by a machine learning method, the deep-learning-based machine learning algorithm based on the training data; and subsequently optimizing at least one parameter of the trained deep-learning-based machine learning algorithm based on a non-differentiable cost function.

### CROSS REFERENCE

The present application claims the benefit under 35 U.S.C. § 119 of German Patent Application No. DE 10 2022 205 999.9 filed on Jun. 14, 2022, which is expressly incorporated herein by reference in its entirety.

### FIELD

The present invention relates to a method for training a deep-learning-based machine learning algorithm, and in particular to a method by which a deep-learning-based machine learning algorithm optimized for a particular application can be trained in a simple manner and with comparatively low resource consumption.

### BACKGROUND INFORMATION

Machine learning algorithms are based on statistical methods being used to train a data processing system in such a way that it can perform a particular task without it being originally programmed explicitly for this purpose. The goal of machine learning is to construct algorithms that can learn and make predictions from data. These algorithms create mathematical models with which data can be classified, for example.

Such machine learning algorithms are used, for example, in the area of driver assistance systems or in the control of autonomously driving motor vehicles. For example, when controlling autonomously driving motor vehicles, it is important to predict as precisely as possible which driving maneuvers further vehicles in the vicinity of the autonomously driving motor vehicle will perform before long, in order to be able to respond as adequately as possible.

Such predictions of future driving maneuvers of further vehicles in the vicinity of autonomously driving motor vehicles are usually based on hidden Markov models. A hidden Markov model is a stochastic model in which a system is modeled by a Markov chain with unobserved states. However, it proves disadvantageous in this respect that performance indicators or requirements with respect to a component or an application that further processes the predictions made by the hidden Markov model are frequently only available in practice in the form of non-continuous or non-differentiable functions. Hidden Markov models are also comparatively simple models, which do not cover all practical situations or dependencies on a regular basis.

A method for training machine learning algorithms is described in PCT Patent Application No. WO 2007/011529 A2, wherein a machine learning algorithm has a set of estimated gradients based at least in part on ordered or sorted outputs generated by the machine learning algorithm. Instead of non-differentiable cost functions, the estimated gradients can be selected to reflect the requirements of a cost function and can be used to determine or modify the parameters of the machine learning algorithm during the training of the machine learning algorithm.

An object of the present invention is thus to specify an improved method for predicting future states.

The object may be achieved by a method for training a deep-learning-based machine learning algorithm adapted to a particular application, according to the present invention.

The object may also achieved by a control device for training a deep-learning-based machine learning algorithm adapted to a particular application, according to the present invention.

### SUMMARY

According to one example embodiment of the present invention, the object is achieved by a method for training a deep-learning-based machine learning algorithm, wherein the method comprises providing training data for training the deep-learning-based machine learning algorithm, wherein the training data comprise sensor data; training, by a machine learning method, the deep-learning-based machine learning algorithm based on training data; and subsequently optimizing at least one parameter of the trained deep-learning-based machine learning algorithm based on a non-differentiable cost function, in particular a non-differentiable cost function with respect to a particular application.

Deep learning, or multi-layered learning, or in-depth learning is understood as a machine learning method that uses artificial neural networks with numerous intermediate layers between the input layer and the output layer and thereby forms an extensive internal structure.

Parameters of a neural network or hyperparameters are furthermore understood to mean parameters that are transferred to the neural network prior to using the neural network and represent properties of the neural network. In order to optimally adapt a neural network to a desired application or a particular use case, which specifies how the predictions made by the trained deep-learning-based machine learning algorithm are to be further processed, hyperparameter optimization is usually performed.

Non-differentiable functions are furthermore understood to mean non-continuous functions that are not differentiable at every point of their domain.

The term “cost function” or “loss” is furthermore understood to mean a loss or an error between ascertained output values of the deep-learning-based machine learning algorithm and corresponding actual circumstances or actual measured data. The term “cost function with respect to a particular application” is furthermore understood to mean a cost function that is tuned or adapted to the respective particular use case or the respective application.

The use of deep-learning-based machine learning algorithms, i.e., of neural networks with several intermediate layers, has an advantage that they can cover significantly more complex situations or scenarios than, for example, hidden Markov models.

That at least one parameter of the deep-learning-based machine learning algorithm is also optimized based on a non-differentiable cost function with respect to the corresponding application also has the advantage that the deep-learning-based machine learning algorithm can also be adapted to performance indicators or requirements with respect to a component or an application, which further processes predictions that are made by the deep-learning-based machine learning algorithm and in practice are frequently available only in the form of non-differentiable functions.

Overall, an improved method for predicting future states is thus specified, wherein the corresponding, improved prediction of future states proves to be advantageous, in particular in safety-critical systems, for example when controlling autonomously driving motor vehicles.

According to an example embodiment of the present invention, the training data furthermore comprise sensor data.

A sensor, which is also referred to as a detector, (measurement or measuring) sensor or (measuring) transmitter, is a technical part that can qualitatively detect particular physical or chemical properties and/or the material characteristics of its surroundings or detect them quantitatively as a measured variable.

Circumstances outside of the actual data processing equipment on which the method is carried out can thus be captured in a simple manner and considered when training the deep-learning-based machine learning algorithm.

According to an example embodiment of the present invention, the step of training the deep-learning-based machine learning algorithm by a machine learning method can comprise training the deep learning classifier based on a differentiable cost function.

Differentiable functions in turn are understood to mean continuous functions that are differentiable at every point of their domain.

The training of the deep-learning-based machine learning algorithm can thus take place in a simple manner based on the respective training data by usual or known methods, without the need for elaborate adaptations of the training process.

In one example embodiment of the present invention, the step of optimizing the at least one parameter of the trained deep-learning-based machine learning algorithm based on a non-differentiable cost function furthermore comprises optimizing the trained deep learning classifier based on temperature scaling.

The term “temperature” is in this respect understood to mean a hyperparameter in neural networks that serves to control the randomness or arbitrariness in predictions made by the neural network or in outputs of the neural network by scaling logits prior to the application of a softmax output layer.

That the step of optimizing the at least one parameter of the trained deep-learning-based machine learning algorithm based on a non-differentiable cost function comprises optimizing the trained deep-learning-based machine learning algorithm based on temperature scaling has the advantage that only one parameter is used to optimize the deep-learning-based classifier so that the resources, in particular memory and/or processor capabilities, required overall to optimize the deep-learning-based machine learning algorithm or to train the deep-learning-based classifier can be significantly reduced.

A further example embodiment of the present invention also specifies a method for controlling a controllable system, wherein the method comprises providing a deep-learning-based machine learning algorithm for controlling a controllable system, wherein the deep-learning-based machine learning algorithm has been trained by a method described above for training a deep-learning-based machine learning algorithm; and controlling the controllable system based on the deep-learning-based machine learning algorithm.

According to an example embodiment of the present invention, the controllable system may, for example, be a robotic system, wherein the robotic system may, for example, in turn be a system for controlling or navigating an autonomously driving motor vehicle.

Specified is thus a method for controlling a controllable system that is based on an improved method for predicting future states, wherein the corresponding, improved prediction of future states proves to be advantageous, in particular in safety-critical systems, for example when controlling autonomously driving motor vehicles. The use of deep-learning-based machine learning algorithms, i.e., of neural networks with several intermediate layers, has the advantage that they can cover significantly more complex situations or scenarios than, for example, hidden Markov models. That at least one parameter of the deep-learning-based machine learning algorithm is also optimized based on a non-differentiable cost function with respect to the corresponding application also has the advantage that the deep-learning-based machine learning algorithm can also be adapted to performance indicators or requirements with respect to a component or an application, which further processes predictions that are made by the deep-learning-based machine learning algorithm, i.e., the controllable system, and in practice are frequently available only in the form of non-differentiable functions.

According to an example embodiment of the present invention, the controllable system may in particular be an automatic distance control of an autonomously driving motor vehicle. For example, when controlling autonomously driving motor vehicles, it is in particular important to predict as precisely as possible which driving maneuvers further vehicles in the vicinity of the autonomously driving motor vehicle will perform before long, in order to be able to respond as adequately as possible.

A further embodiment of the present invention furthermore also specifies a control device for training a deep-learning-based machine learning algorithm, wherein the control device comprises a provisioning unit designed to provide training data for training the deep-learning-based machine learning algorithm, wherein the training data comprise sensor data; a training unit designed to train, by a machine learning method, the deep-learning-based machine learning algorithm based on the training data; and an optimization unit designed to subsequently optimize at least one parameter of the trained deep-learning-based machine learning algorithm based on a non-differentiable cost function, in particular a non-differentiable cost function with respect to a particular application.

An improved control device for predicting future states is thus specified, wherein the corresponding, improved prediction of future states proves to be advantageous, in particular in safety-critical systems, for example when controlling autonomously driving motor vehicles. The use of deep-learning-based machine learning algorithms, i.e., of neural networks with several intermediate layers, has the advantage that they can cover significantly more complex situations or scenarios than, for example, hidden Markov models. That the control device is also designed to optimize at least one parameter of the deep-learning-based machine learning algorithm based on a non-differentiable cost function with respect to a particular application also has the advantage that the deep-learning-based machine learning algorithm can also be adapted to performance indicators or requirements with respect to a component or an application, which further processes predictions that are made by the deep-learning-based machine learning algorithm and in practice are frequently available only in the form of non-differentiable functions.

Again, according to an example embodiment of the present invention, the training data furthermore comprise sensor data. Circumstances outside of the actual data processing equipment on which the training of the deep-learning-based machine learning algorithm is carried out can thus be captured in a simple manner and considered when training the deep-learning-based machine learning algorithm.

In so doing, the training unit can be designed to train the deep-learning-based machine learning algorithm based on a differentiable cost function. The training of the deep-learning-based machine learning algorithm can thus take place in a simple manner based on the respective training data by usual or known methods, without the need for elaborate adaptations of the training process.

In one example embodiment of the present invention, the optimization unit is furthermore designed to optimize the trained deep-learning-based machine learning algorithm based on temperature scaling. That the optimization unit is designed to optimize the trained deep-learning-based machine learning algorithm based on temperature scaling has the advantage that only one parameter is used to optimize the deep-learning-based machine learning algorithm so that the resources, in particular memory and/or processor capabilities, required overall to optimize the deep-learning-based classifier or to train the deep-learning-based machine learning algorithm can be significantly reduced.

A further example embodiment of the present invention moreover also specifies a control device for controlling a controllable system, wherein the control device comprises a provisioning unit designed to provide a deep-learning-based machine learning algorithm for controlling a controllable system, wherein the deep-learning-based machine learning algorithm has been trained by a control device described above for training a deep-learning-based machine learning algorithm; and a control unit designed to control the controllable system based on the deep-learning-based machine learning algorithm.

Specified is thus a control device for controlling a controllable system that is based on an improved control device for predicting future states, wherein the corresponding, improved prediction of future states proves to be advantageous, in particular in safety-critical systems, for example when controlling autonomously driving motor vehicles. The use of deep-learning-based machine learning algorithms, i.e., of neural networks with several intermediate layers, has the advantage that they can cover significantly more complex situations or scenarios than, for example, hidden Markov models. That at least one parameter of the deep-learning-based machine learning algorithm is also optimized based on a non-differentiable cost function with respect to the corresponding application also has the advantage that the deep-learning-based machine learning algorithm can also be adapted to performance indicators or requirements with respect to a component or an application, which further processes predictions that are made by the deep-learning-based machine learning algorithm, i.e., the controllable system, and in practice are frequently available only in the form of non-differentiable functions.

Again, according to an example embodiment of the present invention, the controllable system may in particular be an automatic distance control of an autonomously driving motor vehicle. For example, when controlling autonomously driving motor vehicles, it is in particular important to predict as precisely as possible which driving maneuvers further vehicles in the vicinity of the autonomously driving motor vehicle will perform before long, in order to be able to respond as adequately as possible.

In summary, it should be noted that the present invention specifies a method for training a deep-learning-based machine learning algorithm, and in particular a method by which a deep-learning-based machine learning algorithm optimized for a particular application can be trained in a simple manner and with comparatively low resource consumption.

The described embodiments and developments of the present invention can be combined with one another as desired.

Further possible embodiments, developments and implementations of the present invention also include not explicitly mentioned combinations of features of the present invention described above or below with respect to exemplary embodiments.

### BRIEF DESCRIPTION OF THE DRAWINGS

The figures are intended to provide a better understanding of the embodiments of the present invention. They illustrate embodiments and, in connection with the description, serve to explain principles and concepts of the present invention.

Other embodiments and many of the mentioned advantages will emerge with reference to the figures. The shown elements of the figures are not necessarily drawn to scale with respect to one another.

### BRIEF DESCRIPTION OF THE DRAWINGS

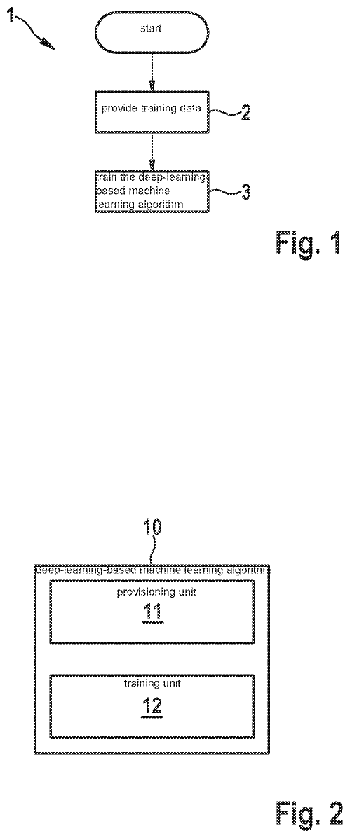

FIG. 1 shows a flow chart of a method for training a deep-learning-based machine learning algorithm according to embodiments of the present invention.

FIG. 2 shows a schematic block diagram of a control device for training a deep-learning-based machine learning algorithm according to embodiments of the present invention.

### DETAILED DESCRIPTION OF EXAMPLE EMBODIMENTS

In the figures, identical reference signs denote identical or functionally identical elements, parts or components, unless stated otherwise.

FIG. 1 shows a flow chart of a method for training a deep-learning-based machine learning algorithm 1 according to embodiments of the present invention.

Machine learning algorithms are based on statistical methods being used to train a data processing system in such a way that it can perform a particular task without it being originally programmed explicitly for this purpose. The goal of machine learning is to construct algorithms that can learn and make predictions from data. These algorithms create mathematical models with which data can be classified, for example.

Such machine learning algorithms are used, for example, in the area of driver assistance systems or in the control of autonomously driving motor vehicles. For example, when controlling autonomously driving motor vehicles, it is important to predict as precisely as possible which driving maneuvers further vehicles in the vicinity of the autonomously driving motor vehicle will perform before long, in order to be able to respond as adequately as possible.

Such predictions of future driving maneuvers of further vehicles in the vicinity of autonomously driving motor vehicles are usually based on hidden Markov models. A hidden Markov model is a stochastic model in which a system is modeled by a Markov chain with unobserved states. However, it proves disadvantageous in this respect that performance indicators or requirements with respect to a component or an application that further processes the predictions made by the hidden Markov model are frequently only available in practice in the form of non-continuous or non-differentiable functions. Hidden Markov models are also comparatively simple models, which do not cover all practical situations or dependencies on a regular basis.

FIG. 1 shows a method for training a deep-learning-based machine learning algorithm 1 adapted to a particular use case, wherein the method 1 comprises a step 2 of providing training data for training the algorithm of the deep-learning-based machine learning algorithm, wherein the training data comprises sensor data; a step 3 of training, by a machine learning method, the deep-learning-based machine learning algorithm based on training data; and a step 4 of subsequently optimizing at least one parameter of the trained deep-learning-based machine learning algorithm based on a non-differentiable cost function, in particular a non-differentiable cost function with respect to a particular application.

The use of deep-learning-based machine learning algorithms, i.e., of neural networks with several intermediate layers, has the advantage that they can cover significantly more complex situations or scenarios than, for example, hidden Markov models.

That at least one parameter of the deep-learning-based machine learning algorithm is also optimized based on a non-differentiable cost function with respect to the corresponding application also has the advantage that the deep-learning-based machine learning algorithm can also be adapted to performance indicators or requirements with respect to a component or an application, which further processes predictions that are made by the deep-learning-based machine learning algorithm and in practice are frequently available only in the form of non-differentiable functions.

Overall, an improved method 1 for predicting future states is thus specified, wherein the corresponding, improved prediction of future states proves to be advantageous, in particular in safety-critical systems, for example when controlling autonomously driving motor vehicles.

In particular, FIG. 1 thus shows a hybrid method for training a deep-learning-based machine learning algorithm 1.

According to the embodiments of FIG. 1, the deep-learning-based machine learning algorithm is in particular a deep-learning-based classifier.

According to the embodiments of FIG. 1, step 2 of training the deep-learning-based machine learning algorithm by a machine learning method furthermore comprises training the deep-learning-based machine learning algorithm based on a differentiable cost function, for example based on a gradient descent method.

According to the embodiments of FIG. 1, step 3 of optimizing the at least one parameter of the trained deep-learning-based machine learning algorithm based on a non-differentiable cost function furthermore comprises optimizing the trained deep-learning-based machine learning algorithm based on temperature scaling.

The optimization based on the temperature scaling can in particular take place based on a Bayesian optimization method. Bayesian optimization methods work best if the corresponding parameter space is small, wherein only one parameter, i.e., the temperature, is considered here. On the other hand, with a high number of parameters or a large parameter space, as occurs, for example, in neural networks with many layers, a Bayesian optimization can usually only be realized with difficulty. Furthermore, however, for example, a grid search method may also be used to optimize the deep-learning-based machine learning algorithm.

The training data furthermore comprise sensor data, wherein the corresponding sensor may in particular be an optical sensor, for example a RADAR sensor, a camera or a LiDAR sensor.

The deep-learning-based machine learning algorithm can subsequently be used in particular for controlling a controllable system, for example an automatic distance control of an autonomously driving motor vehicle.

For example, the deep-learning-based machine learning algorithm may be part of a system for predicting future driving maneuvers of motor vehicles in the vicinity of the autonomously driving motor vehicle, which is trained, for example, to predict, based on captured values with respect to a current speed of a motor vehicle, the current position of the motor vehicle, a relative distance between the motor vehicle and the autonomously driving motor vehicle and, where applicable, a current state of signal lights of the motor vehicle, a future driving maneuver of the motor vehicle, for example whether or not it is likely to change lanes before long. In so doing, the deep-learning-based machine learning algorithm may have been trained on, for example, historical data, or data collected during past trips, or information about relationships between the speed of a motor vehicle and/or the position of the motor vehicle and/or the relative distance of the motor vehicle to an autonomously driving motor vehicle and a subsequent driving maneuver of the motor vehicle.

The predictions made by the deep-learning-based machine learning algorithm may subsequently be used, for example, to determine that vehicle in the vicinity of an autonomously driving motor vehicle based on which an automatic distance control or an adaptive cruise control of the autonomously driving motor vehicle is to be controlled.

FIG. 2 shows a schematic block diagram of a control device for training a deep-learning-based machine learning algorithm 10 according to embodiments of the present invention.

As FIG. 2 shows, the control device 10 comprises a provisioning unit 11 designed to provide training data for training the deep-learning-based machine learning algorithm, wherein the training data comprise sensor data; a training unit 12 designed to train, by a machine learning method, the deep-learning-based machine learning algorithm based on the training data; and an optimization unit 13 designed to subsequently optimize at least one parameter of the trained deep-learning-based machine learning algorithm based on a non-differentiable cost function, in particular a non-differentiable cost function with respect to a particular application.

The provisioning unit may in particular be a receiver designed to receive corresponding data, in particular sensor data. The training unit and the optimization unit may, for example, respectively be realized based on code that is stored in a memory and can be executed by a processor.

According to the embodiments of FIG. 2, the training unit 12 is designed to train the deep-learning-based machine learning algorithm based on a differentiable cost function.

According to the embodiments of FIG. 2, the optimization unit 13 is also designed to optimize the trained deep-learning-based machine learning algorithm based on temperature scaling.

What is claimed is:

1. A method for training a deep-learning-based machine learning algorithm, the method comprising the following steps:
providing training data for training the deep-learning-based machine learning algorithm, the training data including sensor data;
training, by a machine learning method, the deep-learning-based machine learning algorithm based on the training data; and
subsequently, after the training, optimizing at least one parameter of the trained deep-learning-based machine learning algorithm based on a non-differentiable cost function.

2. The method according to claim 1, wherein the training of the deep-learning-based machine learning algorithm by the machine learning method includes training the deep-learning-based machine learning algorithm based on a differentiable cost function.

3. The method according to claim 1, wherein the optimizing of the at least one parameter of the trained deep-learning-based machine learning algorithm based on the non-differentiable cost function includes optimizing the trained deep-learning-based machine learning algorithm based on temperature scaling.

4. A method for controlling a controllable system, the method comprising the following steps:
providing a deep-learning-based machine learning algorithm for controlling a controllable system, wherein the deep-learning-based machine learning algorithm has been trained by:
providing training data for training the deep-learning-based machine learning algorithm, the training data including sensor data,
training, by a machine learning method, the deep-learning-based machine learning algorithm based on the training data, and
subsequently, after the training, optimizing at least one parameter of the trained deep-learning-based machine learning algorithm based on a non-differentiable cost function; and
controlling the controllable system based on the deep-learning-based machine learning algorithm.

5. The method according to claim 4, wherein the controllable system is an automatic distance control of an autonomously driving motor vehicle.

6. A control device for training a deep-learning-based machine learning algorithm, the control device comprising:
a provisioning unit configured to provide training data for training the deep-learning-based machine learning algorithm, wherein the training data includes sensor data;
a training unit configured to train, by a machine learning method, the deep-learning-based machine learning algorithm based on the training data; and
an optimization unit configured to subsequently, after the training, optimize at least one parameter of the trained deep-learning-based machine learning algorithm based on a non-differentiable cost function.

7. The control device according to claim 6, wherein the training unit is configured to train the deep-learning-based machine learning algorithm based on a differentiable cost function.

8. The control device according to claim 6, wherein the optimization unit is configured to optimize the trained deep-learning-based machine learning algorithm based on temperature scaling.

9. A control device for controlling a controllable system, the control device comprises:
a provisioning unit configure to provide a deep-learning-based machine learning algorithm for controlling the controllable system, wherein the deep-learning-based machine learning algorithm has been trained by a control device for training a deep-learning-based machine learning algorithm including:
a second provisioning unit configured to provide training data for training the deep-learning-based machine learning algorithm, wherein the training data includes sensor data,
a training unit configured to train, by a machine learning method, the deep-learning-based machine learning algorithm based on the training data, and
an optimization unit configured to subsequently, after the training, optimize at least one parameter of the trained deep-learning-based machine learning algorithm based on a non-differentiable cost function,
wherein the deep-learning-based machine learning algorithm is adapted to a particular use case; and
a control unit configured to control the controllable system based on the deep-learning-based machine learning algorithm.

10. The control device according to claim 9, wherein the controllable system is an automatic distance control of an autonomously driving motor vehicle.
